(19) United States
(12) Patent Application Publication
(10) Pub. No.: US 2025/0251047 A1
(43) Pub. Date: Aug. 7, 2025

(54) FOUR-WAY BALL VALVE

(71) Applicant: Hanon Systems, Daejeon (KR)

(72) Inventors: Zoltán Horváth, Székesfehérvár (HU); István Pajor, Székesfehérvár (HU); Márk Lelkes, Székesfehérvár (HU)

(21) Appl. No.: 19/044,173

(22) Filed: Feb. 3, 2025

(30) Foreign Application Priority Data
Feb. 2, 2024 (DE) 102024103041.0
Jan. 8, 2025 (DE) 102025100410.2

(51) Int. Cl. F16K 11/087; F25B 41/20

(52) U.S. Cl. CPC F16K 11/0873; F25B 41/20

(57) ABSTRACT

A four-way ball valve having a valve housing and four fluid connection channels arranged therein, a valve ball which can be rotated around an axis of rotation and has a first ball passage channel and a second ball passage channel, three sealing seats for positioning the ball, wherein three fluid connection channels are associated with a respective sealing seat, a drive shaft connected with the ball, and an actuator for rotating the ball, wherein the four fluid connection channels are arranged and the first ball passage channel and the second ball passage channel are wherein at least two switching states of the valve are set by rotation of the ball, wherein two of the fluid connection channels are connected to one another through the first ball passage channel, and the third fluid connection channel is connected to the fourth fluid connection channel through the second ball passage channel.

### CROSS REFERENCE TO RELATED PATENT APPLICATIONS

This patent application claims the benefit of and priority to German Patent Application No. DE 10 2025 100 410.2, filed on Jan. 8, 2025, and German Patent Application No. DE 10 2024 103 041.0 filed Feb. 2, 2024, the entire contents of each of which are incorporated herein by reference for all purposes.

### TECHNICAL FIELD

The invention relates to a four-way ball valve which is suitable for combined heat transfer systems, in particular those which can be operated in the air-conditioning system mode or in the heat pump mode.

### BACKGROUND ART

Modern heat transfer systems combine several different functions. In particular, this applies to combined heat transfer systems which can be operated in the air-conditioning system mode or in the heat pump mode. In this case, the task of changing from one mode to the respective other mode is generally solved by separate valves. In order to reduce the number of components and to save costs, it is sought to reduce the number of necessary valves. However, a new generation of refrigerant ball valves is required for the combination of different functions.

A flow regulation arrangement and a heat regulation system are known from CN 115674992 A, wherein the flow regulation arrangement can be used for the heat regulation system. The flow regulation arrangement comprises a valve block, a first valve element and a second valve element. The first valve element and the second valve element are connected to the valve block in a fixed or limited manner and the flow regulation arrangement is equipped with a channel. The first valve element has two or more operating positions, wherein the first valve element switches the connection modes of the channels by changing the operating positions. The second valve element is connected or not connected to two or more of the channels, so that the first valve element, the second valve element and the valve block form a flow regulation arrangement. Moreover, the first valve element switches the connection modes of the channels and the second valve element is connected or not connected to two or more channels, so that the number of valve elements is decreased and the structure is more compact.

From CN 216923312 U, a five-way valve is known. It comprises a valve body, a ball core and a valve rod, wherein the ball core rotates in the valve body by means of rotation of the valve rod, the circumference and the bottom of the valve body are each in connection with a first conduit body, a second conduit body, a third conduit body, a fourth conduit body and a fifth conduit body, and wherein the ball core has a first flow channel and a second flow channel, respectively, and wherein the first flow channel and the second flow channel are connected to the valve rod. The two ends of the first flow channel and the two ends of the second flow channel each have an outlet, wherein the outlets are each connected to four of the group of conduit bodies, comprising the first conduit body, the second conduit body, the third conduit body, the fourth conduit body and the fifth conduit body, such that double, mutually non-overlapping flow channels are formed. The flow direction of the five-way ball valve is “two in” and “two out”, wherein a ball valve flow channel is divided into two paths, wherein one path is that a bottom conduit body is connected to a path of the conduit body at the side surface, and the other path of the flow channel is that two adjacent 90 degree conduit bodies are connected to one another at the side surface, and wherein the two paths of the flow channels are not connected to one another, and the operation drives the ball valve via the valve rod in order to rotate 0 degrees, 90 degrees, 180 degrees and 270 degrees and select the flow direction corresponding to the switching positions.

### SUMMARY

In order to reduce the number of components and to offer a comparatively more cost-effective solution, a one-valve solution is sought. The object of the invention is to provide a ball valve for switching between different modes in combined heat transfer systems, in particular those which can be operated in an air-conditioning system mode or in a heat pump mode. When constructing this ball valve, the main focus should be on sealing performance and decreasing engine drag torque in order to achieve a comparatively cost-effective solution and to use as much of the components already available as possible.

The object is achieved by a four-way ball valve having the features shown and described herein.

The four-way ball valve according to the invention has a valve housing and four fluid connection channels arranged therein, as well as a valve ball which is placed inside the valve housing and can be rotated around an axis of rotation and has a first ball passage channel and a second ball passage channel separated therefrom, three sealing seats for positioning the valve ball, wherein three of the four fluid connection channels in total each are associated with a sealing seat. Moreover, the four-way ball valve comprises a drive shaft which is in an operative connection with the valve ball and is aligned in the direction of the axis of rotation, and an actuator for rotating the valve ball. The four fluid connection channels are arranged offset from one another in such a way and the first ball passage channel and the second ball passage channel are shaped and positioned in the valve ball in such a way that at least two switching states of the four-way ball valve can be set by means of rotation of the valve ball around the axis of rotation, wherein in each case two of the fluid connection channels with an associated sealing seat are connected to one another through the first ball passage channel and the respective third fluid connection channel with an associated sealing seat is connected to the fourth fluid connection channel, with no associated sealing seat, through the second ball passage channel.

This configuration with three sealing seats and a valve ball with two integrated, separated channels represents a completely new concept. According to the concept according to the invention, three fluid connection channels are sealed with sealing seats and preferably with sealing rings, in particular O-rings, wherein these three fluid connection channels are arranged according to an advantageous embodiment with a rotational offset of 120° around the valve ball. This means that the three fluid connection channels provided with a sealing seat are arranged offset from one another such that, of the three fluid connection channels provided with a sealing seat, two fluid connection channels which are adjacent to one another in the direction of rotation of the valve ball are always aligned with respect to one another at an angle of 120°. The fourth fluid connection channel, which is not provided with a sealing seat, preferably runs in the direction of the axis of rotation and is aligned at an angle of 90° with respect to each of the connection channels provided with a sealing seat. Advantageously, the sealing between a sealing seat and a sealing seat receptacle within the valve housing can be effected by means of a sealing ring, which is generally an O-ring. For receiving the sealing rings, grooves or recesses are formed either in the sealing seat or in the sealing seat receptacle within the valve housing. According to an advantageous embodiment of the invention, the sealing seat receptacles are each formed to be wider than the received sealing seat, so that the sealing seat can be moved laterally within the sealing seat receptacle. Such laterally movable sealing seats are also referred to as floating sealing seats. At high pressure, it acts on the valve ball, pressing the valve ball into the two sealing seats, which “float” and move sideways. The third sealing seat is secured by an O-ring bias, which guarantees a constant tightness and positioning of the sealing seat. A fluid connection channel, which is usually located at the high-pressure inlet, is neither provided with a sealing seat nor otherwise sealed. The high-pressure cavity ensures a lower drag torque acting on the valve ball. In other words, the high-pressure cavity concept is used to reduce the drag torque acting on the valve ball.

The valve housing is preferably formed as a block housing into which sealing seat receptacle inserts for providing the sealing seat receptacle for the sealing seats are inserted into the fluid connection channels. According to a further embodiment of the invention, all four fluid connection channels are arranged with a 90° rotational offset around the valve ball. This means that all four fluid connection channels are offset from one another such that two fluid connection channels of the four fluid connection channels, which are adjacent to one another in the direction of rotation of the valve ball, are always aligned at an angle of 90° to one another. The two ball passage channels integrated into the valve ball are generally of different sizes, wherein the channel with the smaller cross-section preferably serves the high pressure, while the other ball passage channel with the larger cross-section generally serves the low-pressure sections of the system. Previously, these two functions were usually solved by two separate valves. The savings of a valve lead to the following advantages: Less material consumption, as well as a decrease in installation space requirements and costs, not least increased competitiveness on the market. In addition, the embodiment as a four-way type block valve facilitates simple assembly or disassembly in the block. Moreover, simple and accurate production with conventional, readily available parts is possible.

According to a preferred embodiment of the invention, the first ball passage channel, by means of which two of the fluid connection channels with an associated sealing seat are in each case connected to one another, has a larger cross-section than the second ball passage channel, which connects the respective third fluid connection channel with an associated sealing seat to the fourth fluid connection channel with no associated sealing seat. According to a further preferred embodiment, the second ball passage channel is of complex design in that it has at least two differently shaped channel sections. Thus, a first channel section of the second ball passage channel can be formed in a circular-cylindrical manner with a circular channel opening in the surface of the valve ball and can be connected in the interior of the valve ball to a second channel section of the second ball passage channel which is formed as a flat channel with an elongated oval cross-section and a correspondingly oval-shaped channel opening in the valve ball. Advantageously, the differently designed channel sections each have a straight course and are orientated perpendicularly to one another.

A further aspect of the invention relates to the use of the four-way valve according to the invention as a refrigerant valve. As a single four-way valve, which preferably has three so-called “floating sealing seats”, it is capable of connecting high-pressure and low-pressure regions to one another in combined air-conditioning system/heat pump modes of a heat transfer system. As a refrigerant valve, it is suitable for pressures up to 100 bar.

### DESCRIPTION OF DRAWINGS

Further details, features and advantages of designs of the invention are apparent from the following description of exemplary embodiments with reference to the associated drawings. Wherein:

FIG. 1: shows a perspective external view of a four-way ball valve,

FIG. 2: shows an exploded representation of the four-way ball valve,

FIG. 3: shows a perspective representation of a valve ball,

FIG. 4: shows a sectional representation of the four-way ball valve,

FIG. 5: four-way ball valve in a representation of the section along the same plane as in FIG. 4 with another rotational position of the valve ball,

FIG. 6A: shows a cross-sectional representation of the four-way ball valve transverse to the axis of rotation corresponding to a first rotational position of the valve ball,

FIG. 6B: shows a cross-sectional representation of the four-way ball valve transverse to the axis of rotation corresponding to a second rotational position of the valve ball,

FIG. 7: shows a schematic representation of two modes settable by means of the switching states of the four-way ball valve in a refrigerant circuit of a combined heat transfer system,

FIG. 8: shows a schematic representation for explaining the “floating sealing seat” feature,

FIG. 9: shows a cross-sectional representation of the four-way ball valve with sealing seats which each have a recess for receiving a sealing ring,

FIG. 10: shows a perspective external view of a four-way ball valve with four horizontally aligned fluid connection channels, and

FIG. 11: shows a cross-sectional representation of the four-way ball valve with four horizontally aligned fluid connection channels.

### DESCRIPTION OF AN EMBODIMENT

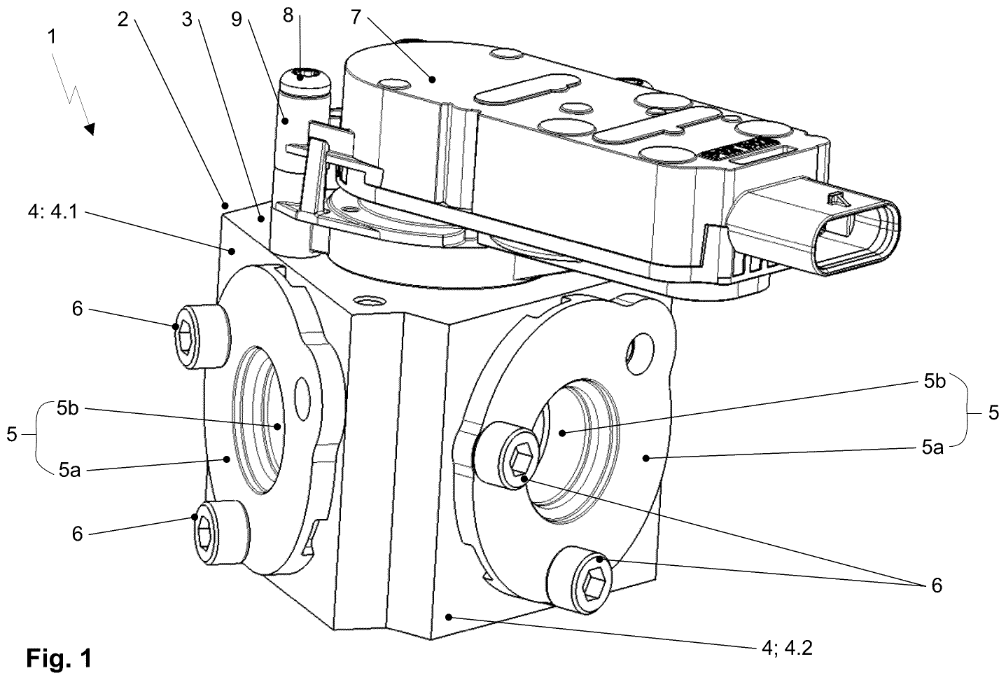

FIG. 1 shows an assembled four-way ball valve 1 in a perspective external view. The four-way ball valve 1 comprises a valve housing 2 which, according to the exemplary embodiment shown in FIG. 1, is designed in the manner of a three-sided prism. Thus, the valve housing 2 has two substantially triangular walls, a bottom wall which is not visible in the representation and an upper housing wall 3, as well as three square housing side walls 4 which are connected to one another in each case at adjacent edges. Like a three-sided prism, the valve housing 2 is thus bounded by two congruent surfaces, by a substantially triangular base surface formed by the non-visible bottom wall and by a likewise substantially triangular top surface formed by the upper housing wall 3, and by three rectangles or squares formed by the housing side walls 4, of which only two housing side walls 4.1, 4.2 are visible in FIG. 1. Accordingly, the valve housing 2 has substantially five differently aligned surfaces, six corner regions and a total of nine edge regions. A respective central circular opening is formed in the housing side walls 4. A sealing seat receptacle insert 5 is inserted into each of the circular openings and fastened to the valve housing 2. The sealing seat receptacle insert 5 comprises a flange ring 5a with a likewise central circular opening which, in the assembled state of the four-way ball valve 1, is concentric with the opening of the respective housing side wall 4 and is adjoined by a hollow-cylindrically shaped part 5b. In the assembled state of the four-way ball valve 1, this hollow-cylindrically shaped part 5b is inserted into the central circular opening of the respective housing side wall 4 of the valve housing 2, while for fastening the sealing seat receptacle insert 5 to the valve housing 2, the flange ring 5a of the sealing seat receptacle insert 5 is fastened to the valve housing 2 by means of fastening elements 6, in the example shown, bolts. An actuator unit 7 with an actuator is placed on the upper housing wall 3 of the valve housing 2, wherein the actuator unit 7 is fastened to the upper housing wall 3 by means of further fastening elements 8, in the example shown, longer screws which are passed through cylindrical sleeves 9 of the actuator unit 7. The actuator unit 7 covers a drive shaft unit which is also fastened on the upper housing wall 3 and has a drive shaft for the valve ball placed in the interior of the valve housing 2 and is not visible due to the mounted actuator unit 7, wherein there is an operative connection between the drive shaft and the actuator of the mounted actuator unit 7.

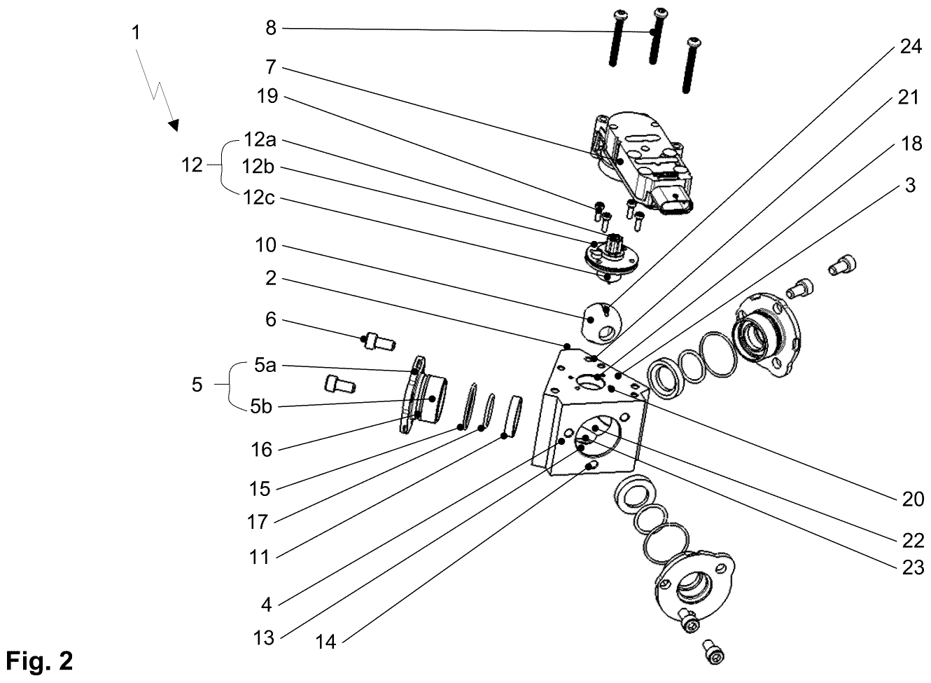

FIG. 2 shows the four-way ball valve 1 in an exploded representation, in which, in addition to the components already visible in FIG. 1, i.e. the valve housing 2, the sealing seat receptacle inserts 5 and the actuator unit 7, and the fastening elements 6, 8 used for fastening the sealing seat receptacle inserts 5 and the actuator unit 7, among other things, the valve ball 10 already mentioned, the sealing seats 11 and the drive shaft unit 12, mentioned as well, with the drive shaft 12a, can be recognised. The valve housing 2 is shown without the inserted sealing seat receptacle inserts 5 and without the mounted actuator unit 7, as a result of which different openings are visible in the upper housing wall 3 and in one of the housing side walls 4. Thus, the visible housing side wall 4, like each of the three housing side walls 4, has a central circular opening 13. During assembly, a sealing seat receptacle insert 5 with its hollow-cylindrically shaped part 5b is inserted into each of the central circular openings 13 of the housing side walls 4, as a result of which the flange ring 5a bears against the housing side wall 4. The sealing seat receptacle insert 5 is then fastened to the respectively abutting housing side wall 4 by means of a connection of the flange ring 5a to the housing side wall 4 by fastening elements 6, for example in the form of bolts, wherein the flange ring 5a has corresponding bores for this purpose. As can be seen in the exploded representation of FIG. 2, several bores 14, which are distributed around the circular opening and are provided, among other things, for receiving fastening elements 6, are also formed in the visible housing side wall 4. A sealing ring 15, which is preferably formed in the shape of an O-ring, is provided on each housing side wall 4 for the sealing between the housing side wall 4 and the respective abutting sealing seat receptacle insert 5. This sealing ring 15 can be placed in a circumferential groove 16 which is advantageously formed on the outer surface of the hollow-cylindrically shaped part 5b of the sealing seat receptacle insert 5 and which is located at one end of the hollow-cylindrically shaped part 5b which adjoins the flange ring 5a. At the opposite end of the hollow-cylindrically formed part 5b of the sealing seat receptacle unit 5, a circumferential recess is formed on the inside thereof, not visible in FIG. 2. This circumferential recess serves as a receptacle for the annular sealing seat 11, hereinafter referred to as the sealing seat receptacle, wherein a further sealing ring 17 is provided for the sealing between the hollow-cylindrically shaped part 5b of the sealing seat receptacle insert 5 and the sealing seat 11, the diameter of which is smaller than the outer diameter of the hollow-cylindrically shaped part 5b and therefore also smaller than the diameter of the sealing ring 15 to be placed on the outer surface of the hollow-cylindrically shaped part. During assembly, this sealing ring 17 can be placed in a groove, not visible in FIG. 2, inside the sealing seat receptacle insert 5 and/or a groove or recess on the rear side of the sealing seat 11. FIG. 2 also shows that a circular feed-through opening 18 is formed in the middle of the upper housing wall 3, which serves to feed through the drive shaft 12a for driving the valve ball 10. The drive shaft 12a is part of the drive shaft unit 12 which, in addition to the drive shaft 12a, has a plate-shaped fastening flange 12b which is connected to a cylindrical feed-through 12c. During assembly, the feed-through 12c is inserted into the feed-through opening 18 and the fastening flange 12b, which then rests on the upper housing wall 3, is fastened to the upper housing wall 3 by means of fastening elements 19, in the example shown four screws. For receiving these fastening elements 19, four corresponding bores 20 are formed in the upper housing wall 3 distributed around the feed-through opening 18. Further bores 21 in the upper housing wall correspond to the fastening elements 8 for the actuator unit 7. FIG. 2 also shows that the valve housing 2 is also formed in the bottom wall 22, the inner side of which is visible, with a central circular opening 23. The valve ball 10 has a first ball passage channel and a second ball passage channel separated therefrom, wherein only one lateral channel opening of one of the two ball passage channels is visible in FIG. 2. Moreover, a cutout 24 is formed in the valve ball 10 on the side aligned in the direction of the drive shaft, which cutout corresponds to an axially projecting engagement element, not visible, of the drive shaft 12a.

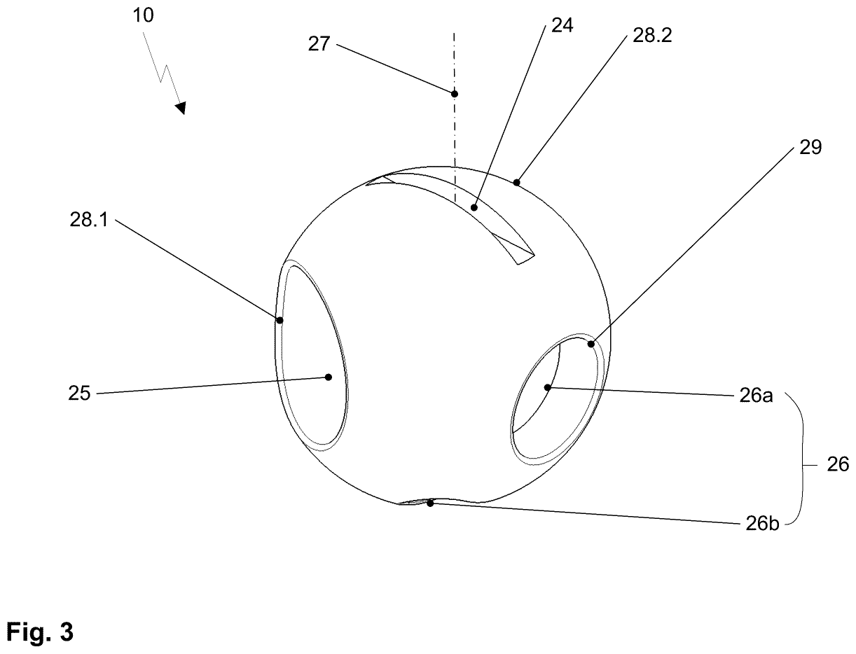

FIG. 3 contains a perspective view of the valve ball 10, wherein in addition to the cutout 24, the two mentioned ball passage channels 25, 26 of the valve ball 10 are also shown. A first ball passage channel 25 runs perpendicularly to the direction of the axis of rotation 27 through the valve ball 10, as a result of which two further circular channel openings 28.1, 28.2 are formed in the valve ball. The second circular channel opening 28.2 is not directly visible in FIG. 3, only its position is indicated. A second ball passage channel 26 separated from the first ball passage channel 25 comprises two channel sections 26a, 26b which meet one another and are differently shaped. A first channel section 26a is circular-cylindrical with a corresponding circular channel opening 29 in the surface of the valve ball 10. The first channel section 26a, which is orientated perpendicularly to an axis of rotation 27 of the valve ball 10, is placed centrally, i.e. its extended cylinder axis runs through the ball centre. This circular-cylindrical channel section 26a is connected in the interior of the valve ball 10 to a second channel section 26b formed as a flat channel with an elongated oval cross section, wherein the elongated oval shape of the cross-section and the channel opening in the surface of the valve ball 10 are not visible in FIG. 3. The channel sections 26a, 26b, which have a straight course, are orientated perpendicularly, i.e. at an angle of 90 degrees to one another. The first, circular-cylindrical shaped channel section 26a is shorter than the radius of the valve ball 10, as a result of which the second channel section 26b, which lies at an angle of 90 degrees and has an elongate oval cross-section, runs parallel to the axis of rotation 27 of the valve ball 10 outside the centre of the valve ball 10. The cross-section of the first ball passage channel 25 is larger than the two different cross-sections of the second ball passage channel 26.

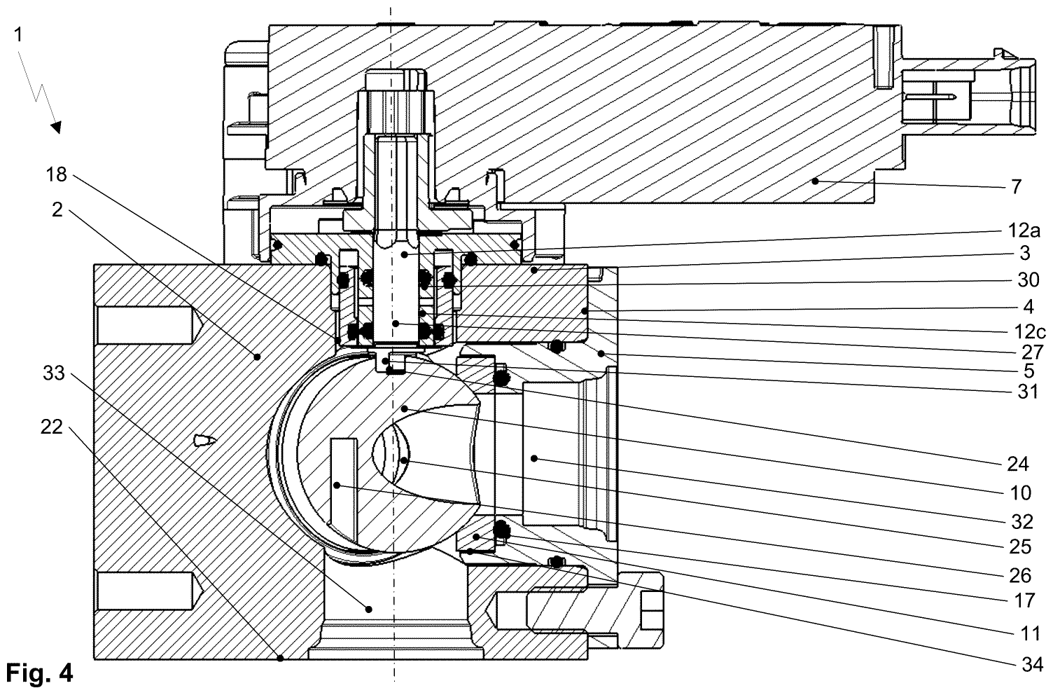

FIG. 4 shows the assembled four-way ball valve 1 in a section along the axis of rotation 27 of the drive shaft 12a. The drive shaft 12a is passed through the upper housing wall 3 of the valve housing 2 along the feed-through 12c sealed by several sealing elements 30, passes through the feed-through opening 18 formed in the upper housing wall 3 and finally engages with its axially projecting engagement element 31 into the corresponding cutout 24 of the valve ball 10 in order to enter into an operative connection with the valve ball 10. Moreover, FIG. 4 contains a schematic representation of the actuator unit 7, which is placed on the upper housing wall 3 of the valve housing 2 and covers the drive shaft unit 12, wherein an upper end of the drive shaft 12a is accommodated in the actuator unit 7 and an operative connection is formed between the actuator contained in the actuator unit 7 and the drive shaft 12a. In total, four different fluid connection channels 32, 33 are formed in the valve housing 2, of which a total of three fluid connection channels 32, each of which leads through one of the three housing side walls 4 and each of which is associated with a sealing seat 11 for the valve ball 10, as well as a fluid connection channel 33 formed in the bottom wall 22. Each of the fluid connection channels 32, which in each case leads through a housing side wall 4, is covered with a sealing seat receptacle insert 5 inserted into the valve housing 2. In the sectional representation of FIG. 3, only one of these fluid connection channels 32 with a sealing seat 11 is visible, which, together with an additional sealing ring 17, is placed inside a sealing seat receptacle 34 formed by the sealing seat receptacle insert 5 inserted at this point, which receptacle is in the form of a circumferential step-shaped recess on the inside of the sealing ring receptacle insert 5. The valve ball 10 is placed inside the valve housing 2 between the fluid connection channels 32, 33 so as to be rotatable around the axis of rotation 27. As already mentioned, the first ball passage channel 25 and the second ball passage channel 26 separated therefrom are formed in the valve ball 10. The fluid connection channel 33 formed in the bottom wall 22 is not provided with a sealing seat and is not sealed. This fluid connection channel 33 is provided for a high-pressure inlet, wherein in this case the so-called high-pressure cavity concept is used to decrease the drag torque acting on the valve ball 10. The two ball passage channels 25, 26 integrated in the valve ball 10 are of different sizes in terms of their cross-section, wherein the ball passage channel 26 with the smaller cross-section is always adapted for the high pressure and therefore, in each rotational position of the valve ball, is in connection with the fluid connection channel 33 provided for the high-pressure inlet in the bottom wall 22, while the other ball passage channel 25 with the larger cross-section is always intended for the low-pressure sections of the fluid system. The sectional representation of FIG. 2 corresponds to a mode in which a connection of the larger ball passage channel 25 with the shown fluid connection channel 32, which runs through the housing side wall 4 and is covered with a sealing seat receptacle insert 5, is produced.

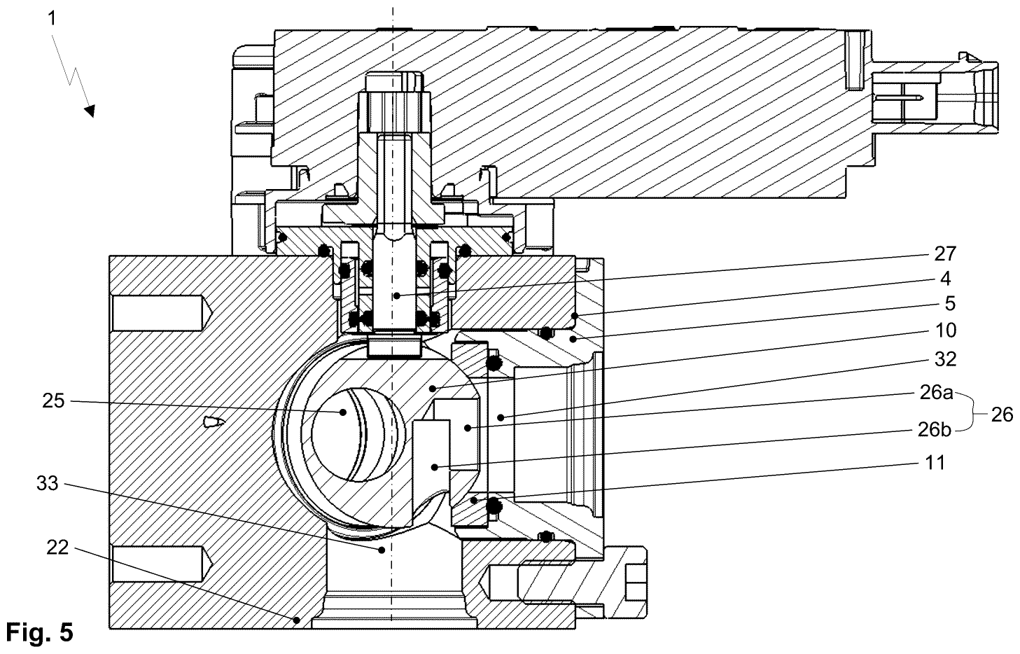

FIG. 5 shows the four-way ball valve 1 in a representation of the section along the same plane as in FIG. 4, with the difference that, by rotation of the valve ball 10 around the axis of rotation 27, the second ball passage channel 26 is now aligned with its first, circular-cylindrical channel section 26a such that a connection exists between the fluid connection channel 33 in the bottom wall 22 and the shown fluid connection channel 32 in the housing side wall 4 covered with a sealing seat receptacle insert 5 and provided with a sealing seat 11. Because the second channel section 26b of the second ball passage channel 26 runs parallel to the axis of rotation 27 of the valve ball 10 in each rotational position, there is a direct connection between the second ball passage channel 26 and the fluid connection channel 33 formed in the bottom wall 22, with no associated sealing seat, in each rotational position of the valve ball 10 or in each mode. The first ball passage channel 25 simultaneously establishes a connection between the two further fluid connection channels which each run through a housing side wall of the valve housing 2 and which are not visible in FIG. 5.

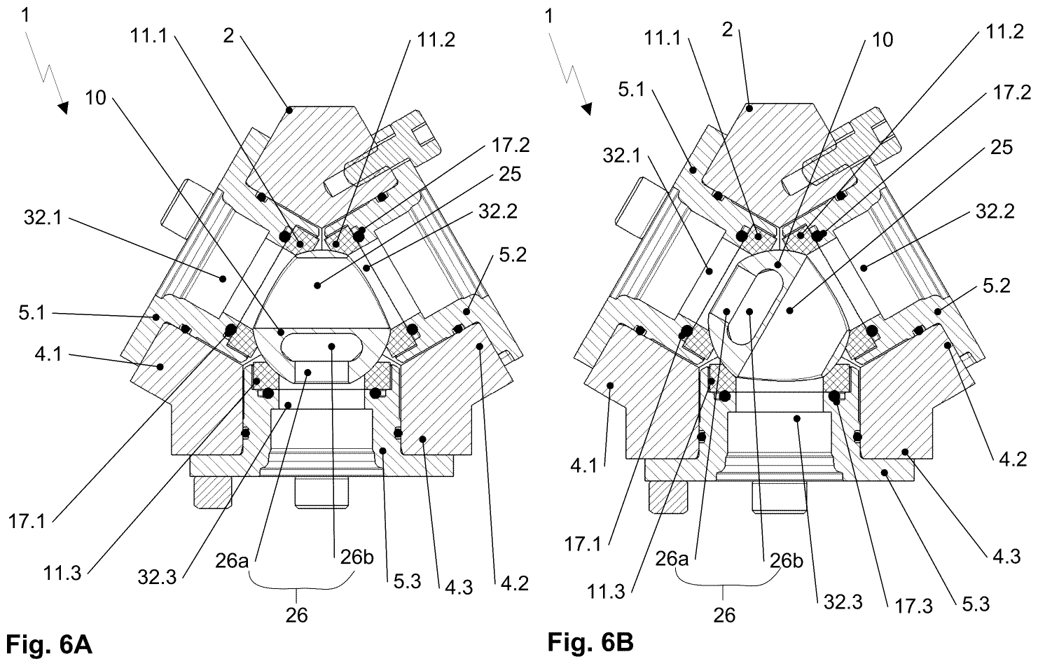

Figures FIG. 6A and FIG. 6B represent cross-sections of the four-way ball valve 1 transversely to the axis of rotation along the same plane, but with different rotational positions of the valve ball 10 and different alignment of the ball passage channels 25, 26 for comparison purposes. In the exemplary embodiment shown, the three fluid connection channels 32.1, 32.2; 32.3, which are provided with a sealing seat 11.1; 11.2; 11.3 in combination with a respective sealing ring 17.1; 17.2; 17.3, are arranged around the valve ball 10 such that two fluid connection channels 32.1, 32.2; 32.3, which are adjacent to one another in the direction of rotation of the valve ball 10, are always aligned at an angle of 120° to one another. In the embodiment shown in Figures FIG. 6A and FIG. 6B, the grooves for the sealing rings 17.1; 17. 2; 17.3, which each provide for a sealing between one of the sealing seat receptacle inserts 5.1; 5.2; 5.3 and the sealing seat 11.1; 11.2; 11.3 received therein, are formed in the sealing seat receptacle inserts 5.1; 5.2; 5.3. The fluid connection channel orientated perpendicularly to the fluid connection channels 32.1, 32.2, 32.3, to which no sealing seat is associated and which runs through the bottom wall, is not depicted in the Figures FIG. 6A and FIG. 6B. In the switching position of the four-way ball valve 1 represented in FIG. 6A, the first ball passage channel 25 of the valve ball 10 establishes a connection between a first fluid connection channel 32.1, which is provided with a sealing seat 11.1 and runs through a first housing side wall 4.1, and the adjacent second fluid connection channel 32.2, which is also provided with a sealing seat 11.2 and runs through a second housing side wall 4.2. Both fluid connection channels 32.1, 32.2 are orientated at an angle of 120° to one another. At the same time, the second, complexly designed ball passage channel 26 provides for a connection between the fluid connection channel 33, not shown, which runs through the bottom wall of the four-way ball valve 1, and the third fluid connection channel 32.3, which is orientated at right angles thereto and is provided with a sealing seat 11.3. On one side of the ball passage channel 26, there is a direct connection between the circular-cylindrical first channel section 26a and the third fluid connection channel 32.3 and on the other side of the ball passage channel 26, there is a direct connection between the second channel section 26b and the fourth fluid connection channel 33, not shown, which runs through the bottom wall and has no sealing seat. In the switching position of the four-way ball valve 1 represented in FIG. 6B, the valve ball 10 has rotated through an angle of rotation of 120° in comparison with the switching position in FIG. 6A. The first ball passage channel 25 of the valve ball 10 now connects the second fluid connection channel 32.2, which is provided with a sealing seat 11.2, to the third fluid connection channel 32.3, which is provided with a sealing seat, wherein these two fluid connection channels 32.2, 32.3, which are adjacent in the direction of rotation of the valve ball 10, are also aligned at an angle of 120° to one another. The second ball passage channel 26 establishes a connection between the fluid connection channel 33, not shown, without a sealing seat, and the first fluid connection channel 32.1, which is orientated at right angles thereto and has a sealing seat 11.1. As a result of the rotation of the valve ball by 120° in comparison to the switching position depicted in FIG. 6A, the first channel section 26a of the second ball passage channel 26 is now orientated in the direction of the first fluid connection channel 32.1 and directly connected thereto. Because the adjacent second channel section 26b, which has an elongate oval cross-section, runs parallel to the axis of rotation of the valve ball 10 outside the centre of the valve ball 10, it is in every rotational position of the valve ball and thus in every switching position in connection with the fluid connection channel provided for the high-pressure inlet in the bottom wall. As can be seen from Figures FIG. 6A and FIG. 6B, the angle of rotation of the valve ball 10 of the four-way ball valve 1 between the two switching states is 120°.

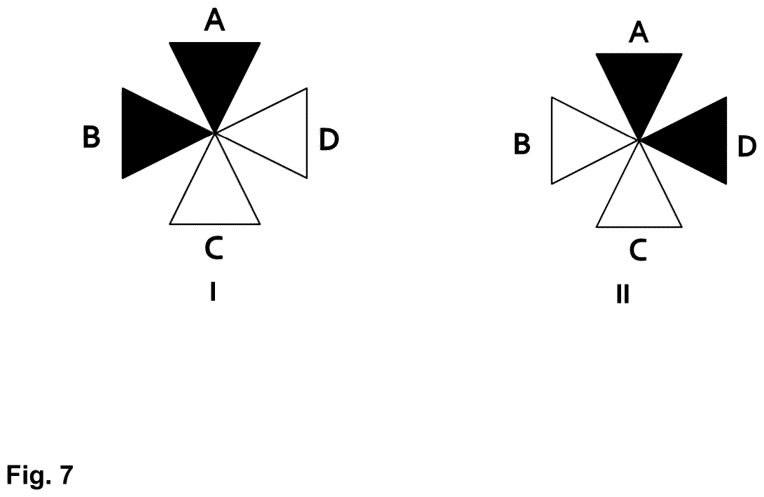

FIG. 7 contains a schematic representation of two modes I and II which can be adjusted by means of the switching positions of the four-way ball valve in a refrigerant circuit of a combined heat transfer system, wherein the letters A to D designate components or regions in the refrigerant circuit. The letter A corresponds to a compressor outlet, i.e. the side of the compressor on which high pressure is present, while the letter C corresponds to the suction side or low-pressure side of the compressor. The letter B denotes a condenser and the letter D denotes an evaporator. The regions connected to one another in the respective mode are represented in the same way, i.e. by white or black triangles. In mode I, the high-pressure side of the compressor A is connected to the condenser B, while at the same time there is a connection from the evaporator D to the low-pressure side C of the compressor. In mode II, the four-way ball valve is in a switching position which establishes a connection from the high-pressure side of the compressor A to the evaporator D and a connection from the condenser B to the low-pressure side C of the compressor.

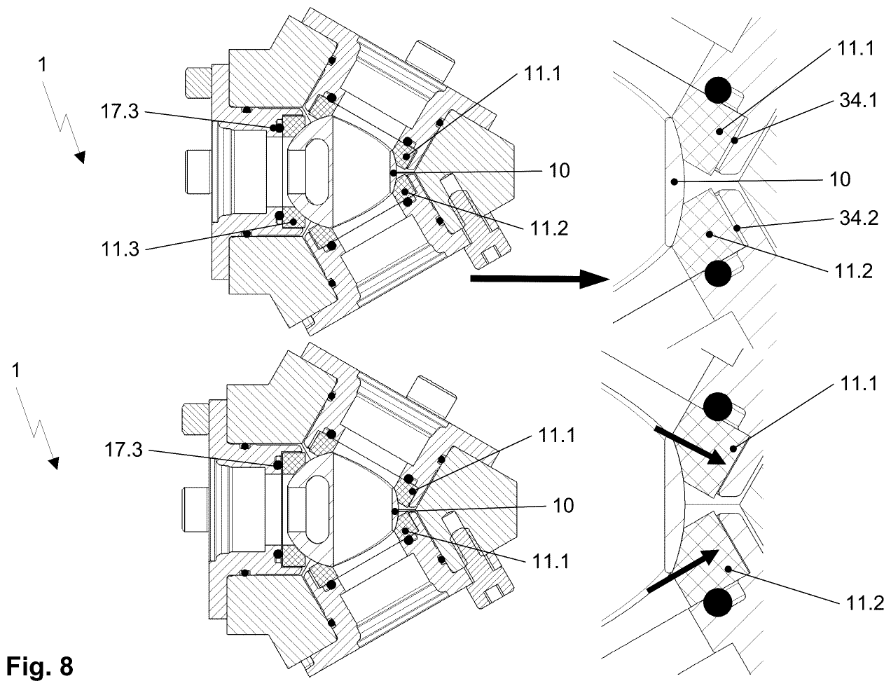

FIG. 8 serves as a schematic representation for explaining what is to be understood by a so-called “floating sealing seat”. Due to the high pressure acting on the valve ball 10 and indicated by arrows in FIG. 8, the valve ball 10 is pressed into the two adjacent sealing seats 11.1, 11.2. The sealing seats 11.1, 11.2 themselves are each located within a sealing seat receptacle 34.1; 34.2 which is somewhat wider in the lateral direction, i.e. transversely to the annular axis of the respective sealing seat 11.1; 11.2, than the sealing seat 11.1; 11.2 itself. Thus, as can be recognised in the upper illustrations of FIG. 8, a gap remains in each of the two sealing seat receptacles 34.1; 34.2, which opens up a clearance for movement in each of the two sealing seat receptacles 34.1, 34.2. The pressure, in connection with this clearance for movement, causes the sealing seats 11.1, 11.2 to move sideways, in other words to “float”. The third sealing seat 11.3 is secured by prestressing the associated sealing ring 17.3 embodied as an O-ring, wherein this prestressing guarantees a constant tightness and positioning of the sealing seat 11.3.

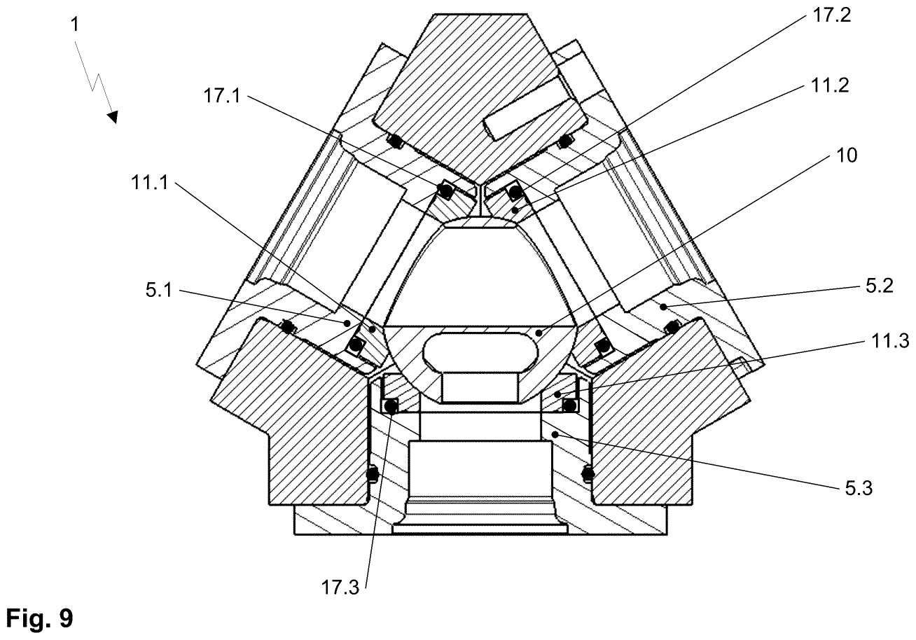

FIG. 9 shows a cross-sectional representation of a four-way ball valve 1 with sealing seats 11.1, 11.2, 11.3, wherein, in contrast to the exemplary embodiments shown above for the sealing rings 17.1, 17.2, 17.3, which each provide for sealing between one of the sealing seat receptacle inserts 5.1; 5.2; 5.3 and the sealing seat 11.1; 11.2; 11.3 received therein, no grooves are formed in the sealing seat receptacle inserts 5.1; 5.2; 5.3. However, the sealing seats 11.1, 11.2, 11.3 each have on their rear side, i.e. on the side facing away from the valve ball 10, a circumferential recess for receiving the assigned sealing ring 17.1; 17.2; 17.3.

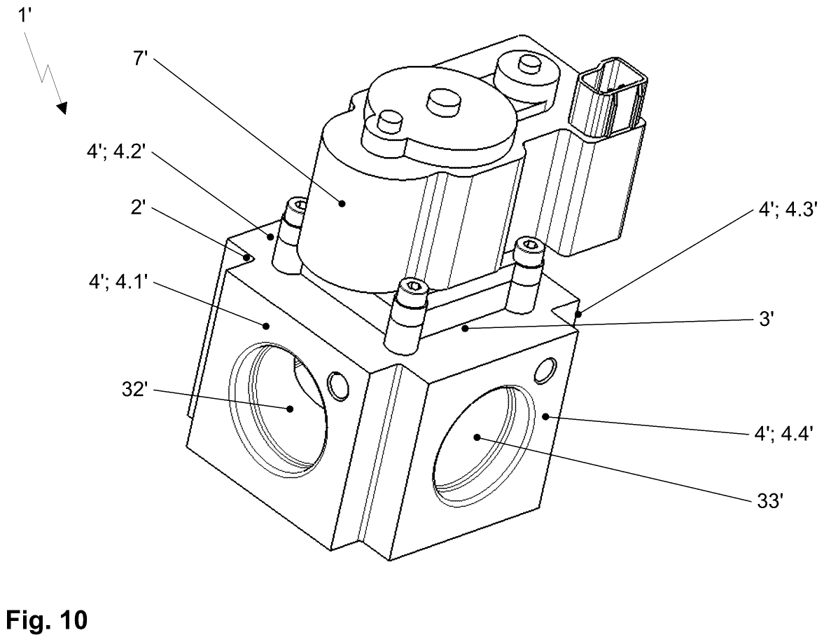

The invention is also applicable to four-way ball valves with four horizontally aligned fluid connection channels. Such a four-way ball valve 1′is depicted in FIG. 10. It comprises a valve housing 2′ which is designed in the manner of a cube according to the exemplary embodiment shown in FIG. 1. Thus, the valve housing 2′ has six substantially square walls, of which a bottom wall, which is not visible in the representation, and an upper housing wall 3′, on which an actuator unit 7′ for the valve ball is fastened, as well as four likewise square housing side walls 4′; 4.1′, 4.2′, 4.3′, 4.4′. A horizontally aligned fluid connection channel 32′; 33′ runs through each of these four housing side walls 4.1′, 4.2′, 4.3′, 4.4′.

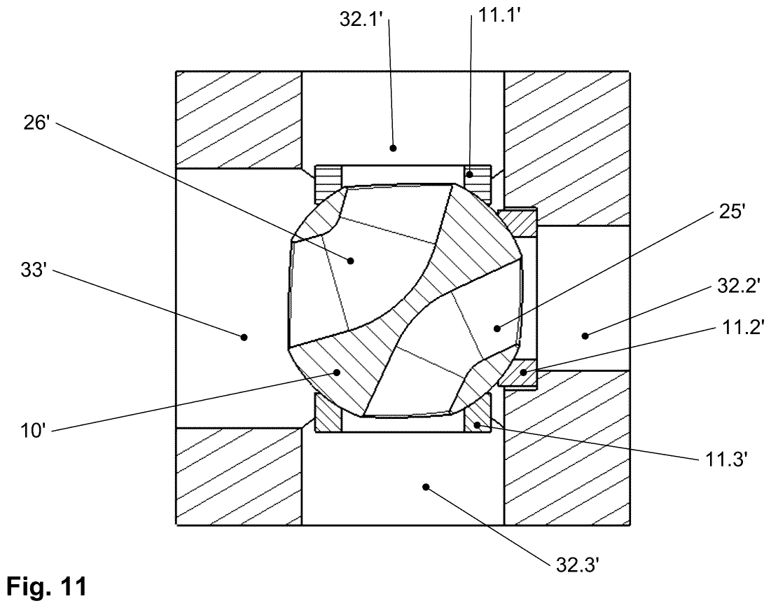

FIG. 11 contains a corresponding cross-sectional representation of the four-way ball valve 1′, in which the four horizontally aligned fluid connection channels 32.1′, 32.2′, 32.3′, 33′ are visible. Three fluid connection channels 32.1′, 32.2′, 32.3′ are each associated with a sealing seat 11.1′; 11.2′; 11.3′ for positioning the valve ball 10′ in accordance with the invention, while the fourth fluid connection channel 33′ is not provided with a sealing seat. In the spirit of the invention, a first ball passage channel 25′ and a second ball passage channel 26′ separated therefrom are also formed in the valve ball 10′. All four fluid connection channels 32.1′, 32.2′, 32.3′, 33′ are arranged with a 90° rotational offset around the valve ball 10′ according to the representation in FIG. 11. The ball passage channels 25′, 26′ are each formed to be curved, such that in any possible switching position they can connect adjacent fluid connection channels 33′, 32.1′; 32.2′, 32.3′, which are aligned at an angle of 90° to one another, to one another. This approach is suitable if larger valve balls have to be used because of connecting channels with a larger cross-section.

### LIST OF REFERENCE NUMERALS

1; 1′ four-way ball valve
2; 2′ valve housing
3; 3′ upper housing wall
4; 4′ housing side wall
4.1; 4.1′ housing side wall
4.2; 4.2′ housing side wall
4.3; 4.3′ housing side wall
4.4′ housing side wall
5; 5.1; 5.2; 5.3 sealing seat receptacle insert
5a flange ring
5b hollow-cylindrically shaped part
6 fastening element (bolt)
7; 7′ actuator unit
8 fastening element (screw)
9 sleeve of the actuator unit for receiving a fastening element
10; 10′ valve ball
11; 11.1; 11.2; 11.3; 11.1′; sealing seat
11.2′; 11.3′
12 drive shaft unit
12a drive shaft
12b fastening flange for fastening the drive shaft unit on the upper housing wall
12 feed-through
13 central opening in a housing side wall
14 bores in a housing side wall for receiving fastening elements for fastening a sealing seat receptacle insert
15 sealing ring
16 circumferential groove
17; 17.1; 17.2; 17.3 sealing ring
18 feed-through opening in the upper housing wall
19 fastening element for fastening the drive shaft unit
20 bores in the upper housing wall for receiving fastening elements for fastening the drive shaft unit
21 bores in the upper housing wall for receiving fastening elements for fastening the actuator unit
22 bottom wall
23 central opening in the bottom wall
24 cutout in the valve ball
25; 25′ first ball passage channel
26; 26° second ball passage channel
26a first channel section of the second ball passage channel
26b second channel section of the second ball passage channel
27 axis of rotation
28.1 channel opening in the valve ball
28.2 channel opening in the valve ball
29 circular channel opening in the valve ball
30 sealing elements
31 engagement element
32; 32′ fluid connection channel with an associated sealing seat
32.1; 32.1′ fluid connection channel with an associated sealing seat
32.2; 32.2′ fluid connection channel with an associated sealing seat
32.3; 32.3′ fluid connection channel with an associated sealing seat
33; 33′ fluid connection channel with an associated sealing seat
34; 34.1; 34.2 sealing seat receptacle

What is claimed is:

1. A four-way ball valve comprising:
a valve housing and four fluid connection channels arranged therein, a valve ball placed inside the valve housing and rotated around an axis of rotation and has a first ball passage channel and a second ball passage channel separated therefrom, three sealing seats for positioning the valve ball, wherein three of the four fluid connection channels are associated with a respective sealing seat;
a drive shaft, which is in an operative connection with the valve ball and is aligned in the direction of the axis of rotation, and
an actuator for rotating the valve ball, wherein the four fluid connection channels are arranged offset from one another in such a way and the first ball passage channel and the second ball passage channel are shaped and positioned in the valve ball in such a way that at least two switching states of the four-way ball valve can be set by rotation of the valve ball around the axis of rotation, wherein in each case two of the four fluid connection channels with an associated sealing seat are connected to one another through the first ball passage channel, and a respective third one of the four fluid connection channels with an associated sealing seat is connected to a fourth one of the four fluid connection channels with no associated sealing seat, through the second ball passage channel.

2. The four-way ball valve according to claim 1, wherein the three of the four fluid connection channels provided with a sealing seat are arranged offset from one another such that, of the three of the four fluid connection channels provided with a sealing seat, the two of the four fluid connection channels which are adjacent to one another in the direction of rotation of the valve ball are always aligned at an angle of 120° to one another and a rotational offset is 120°.

3. The four-way ball valve according to claim 1, wherein the fourth of the four fluid connection channels, which is not provided with a sealing seat, is aligned at an angle of 90° in the direction of the axis of rotation and with respect to each of the three of the four fluid connection channels provided with a sealing seat.

4. The four-way ball valve according to claim 1, wherein sealing between a sealing seat and a sealing seat receptacle takes place inside the valve housing by a sealing ring.

5. The four-way ball valve according to claim 4, wherein the sealing ring is placed in a recess or a groove in the sealing seat.

6. The four-way ball valve according to claim 4, wherein the sealing ring is placed in a recess or a groove in the sealing seat receptacle.

7. The four-way ball valve according to claim 4, wherein the sealing seat receptacles are each formed to be wider than the sealing seat, so that the sealing seat can be moved laterally within the sealing seat receptacle.

8. The four-way ball valve according to claim 4, wherein the valve housing is formed as a block housing into which sealing seat receptacle inserts for providing the sealing seat receptacle for the sealing seat are inserted into the four fluid connection channels.

9. The four-way ball valve according to claim 1, wherein all of the four fluid connection channels are arranged offset from one another such that the two of the four fluid connection channels of the four fluid connection channels which are adjacent to one another in the direction of rotation of the valve ball are always aligned with respect to one another at an angle of 90° and a rotational offset is 90°.

10. The four-way ball valve according to claim 1, wherein the first ball passage channel and the second ball passage channel have cross-sections of different sizes.

11. The four-way ball valve according to claim 10, wherein the first ball passage channel, through which in each case the two of the four fluid connection channels with an associated sealing seat are in connection with one another, has a larger cross-section than the second ball passage channel which connects the respective third of the four fluid connection channels with an associated sealing seat to the fourth of the four fluid connection channels with no associated sealing seat.

12. The four-way ball valve according to claim 1, wherein the second ball passage channel has at least two differently shaped channel sections.

13. The four-way ball valve according to claim 12, wherein a first one of the at least two differently shaped channel sections of the second ball passage channel is circular-cylindrically shaped with a circular channel opening in a surface of the valve ball, wherein the first one of the at least two differently shaped channel sections is connected in an interior of the valve ball to a second one of the at least two differently shaped channel sections of the second ball passage channel formed as a flat channel with an elongate oval cross-section and a correspondingly formed channel opening in the valve ball.

14. The four-way ball valve according to claim 13, wherein the first one of the at least two differently shaped channel sections and the second one of the at least two differently shaped channel sections each have a straight course and are orientated perpendicularly to one another.

15. A use of the four-way ball valve according to claim 1 as a refrigerant valve.
